(19) United States
(12) Patent Application Publication
(10) Pub. No.: US 2021/0214991 A1
(43) Pub. Date: Jul. 15, 2021

(54) PRESENCE BASED LIFTGATE OPERATION

(71) Applicant: GM GLOBAL TECHNOLOGY OPERATIONS LLC, Detroit, MI (US)

(72) Inventors: Gabriel A. Cruz, Novi, MI (US); Connor A. Tagg, Berkley, MI (US); David T. Proefke, Troy, MI (US); Princess Len M. Carlos, Sterling Heights, MI (US)

(21) Appl. No.: 16/740,850

(22) Filed: Jan. 13, 2020

(51) Int. Cl. E05F 15/76; B60R 25/24; B60R 25/01; E05F 15/73

(52) U.S. Cl. CPC E05F 15/76; B60R 25/24; B60R 25/01; E05Y 2400/852; E05Y 2400/45; E05Y 2900/546; E05F 2015/767

(57) ABSTRACT

One general aspect includes a method for presence-based vehicle door operation, the method including: establishing a defined zone in an environment surrounding a vehicle; recognizing a presence of a user within the zone; recognizing the user has remained within the zone for a prescribed time period; recognizing the user no longer remains within the zone; and causing the vehicle door to open after recognizing the user no longer remains within the zone.

### INTRODUCTION

Known hands-free liftgate systems are useful for those times when a vehicle operator cannot freely use their hands, for example, when they are holding groceries or other large objects. To activate these systems, the vehicle operator must kick their foot below their vehicle's rear bumper fascia or press a button on their keyfob as they approach the liftgate. However, these systems can be difficult for vehicle operators to use when they are unfamiliar with the required foot motion, have poor balance or slow reaction times, or cannot properly access their keyfob (likely because it is in their pocket while they are holding groceries or large objects). It is therefore desirable to provide a system and method that can allow a vehicle operator to operate their vehicle's liftgate simply by being present behind the rear bumper facia of the vehicle. It is also desirable for this system and method to determine the vehicle operator's intent to operate the liftgate before allowing liftgate operations to occur. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for presence-based vehicle door operation, the method including: establishing a defined zone in an environment surrounding a vehicle; recognizing a presence of a user within the zone; recognizing the user has remained within the zone for a prescribed time period; recognizing the user no longer remains within the zone; and causing the vehicle door to open after recognizing the user no longer remains within the zone. Other embodiments of this aspect include corresponding computer systems, apparatus, and computer programs recorded on one or more computer storage devices, each configured to perform the actions of the methods.

Implementations may include one or more of the following features. The method further including: recognizing the movement of the user within the zone; determining an intent of the user based on the movement of the user within the zone; and based on the intent of the user, causing the vehicle door to open. The method further including: providing an acknowledgement cue after recognizing the presence of the user. The method further including: providing an initiation cue after recognizing the user has remained within the zone for the prescribed time period. The method where the prescribed period of time is at least two (2) seconds. The method where the user is identified based on the location of a keyfob in relation to the zone. Implementations of the described techniques may include hardware, a method or process, or computer software on a computer-accessible medium.

One general aspect includes a method for presence-based vehicle door operation, the method including: establishing a defined zone in an environment surrounding a vehicle; receiving a signal to close the vehicle door; recognizing a user no longer remains within the zone; and causing the vehicle door to close after recognizing the user no longer remains within the zone. Other embodiments of this aspect include corresponding computer systems, apparatus, and computer programs recorded on one or more computer storage devices, each configured to perform the actions of the methods.

Implementations may include one or more of the following features. The method where: when the user is recognized to remain within the zone beyond a prescribed time period, inhibit the vehicle door from being able to close. The method further including: providing an acknowledgement cue after receiving the signal. The method where the user is identified based on the location of a keyfob in relation to the zone. The method where the signal is provided by a button located in proximity to the zone. Implementations of the described techniques may include hardware, a method or process, or computer software on a computer-accessible medium.

One general aspect includes a method for presence-based vehicle door operation, the method including: establishing a defined zone in an environment behind of the vehicle door of a vehicle; recognizing a presence of a user within the zone; recognizing the user has remained within the zone for a prescribed time period; for a first time, recognizing the user no longer remains within the zone; causing the vehicle door to open after recognizing the user no longer remains within the zone for the first time; after the user returns to the zone, receiving a signal to close the vehicle door; for a second time, recognizing the user no longer remains within the zone; and causing the vehicle door to close after recognizing the user no longer remains within the zone for the second time. Other embodiments of this aspect include corresponding computer systems, apparatus, and computer programs recorded on one or more computer storage devices, each configured to perform the actions of the methods.

Implementations may include one or more of the following features. The method further including: recognizing the movement of the user within the zone; determining an intent of the user based on the movement of the user within the zone; and based on the intent of the user, causing the vehicle door to open and/or close. The method further including: providing an acknowledgement cue after recognizing the presence of the user. The method further including: providing an initiation cue after recognizing the user has remained within the zone for the prescribed time period. The method where the prescribed period of time is at least two (2) seconds. The method where the user is identified based on the location of a keyfob in relation to the zone. The method where: after the user returns to the zone, when the user is recognized to remain within the zone for a second prescribed time period, inhibit the vehicle door from being able to close. The method further including: providing an acknowledgement cue after receiving the signal. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of an electronics system capable of utilizing the system and method disclosed herein;

FIG. 2 is an exemplary flow chart for the utilization of exemplary system and method aspects disclosed herein;

FIG. 3 is an illustrative aspect of the process flow of FIG. 2;

FIG. 4 is another illustrative aspect of the process flow of FIG. 2; and

FIG. 5 is another illustrative aspect of the process flow of FIG. 2.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

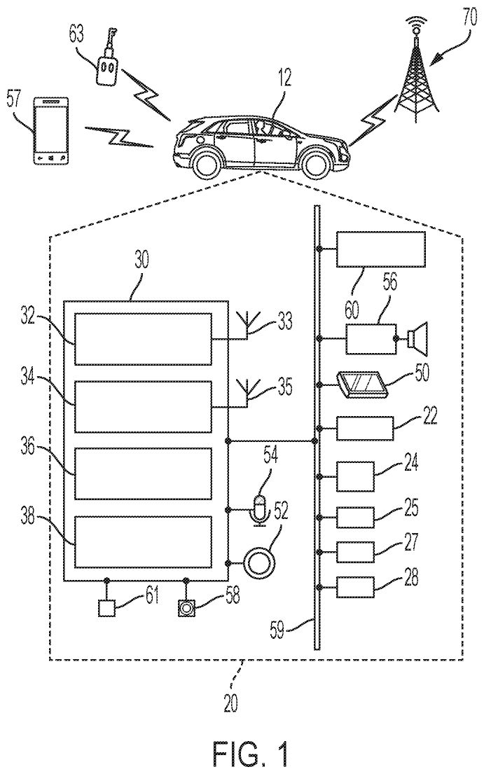

With reference to FIG. 1, vehicle 12 is depicted in the illustrated embodiment as a sports utility vehicle (SUV), but it should be appreciated that any other vehicle including motorcycles, trucks, passenger sedan, recreational vehicles (RVs), marine vessels, aircraft including unmanned aerial vehicles (UAVs), etc., can also be used. In certain embodiments, vehicle 12 may include a power train system with multiple generally known torque-generating devices including, for example, an engine. The engine may be an internal combustion engine that uses one or more cylinders to combust fuel, such as gasoline, in order to propel vehicle 12. The power train system may alternatively include numerous electric motors or traction motors that convert electrical energy into mechanical energy for propulsion of vehicle 12.

Some of the vehicle electronics 20 are shown generally, in FIG. 1 and includes a global navigation satellite system (GNSS) receiver 22, a body control module or unit (BCM) 24, and other vehicle system modules (VSMs) 28, a telematics unit 30, vehicle-user interfaces 50-61, and onboard computer 60. Some or all of the different vehicle electronics may be connected for communication with each other via one or more communication busses, such as communication bus 59. The communication bus 59 provides the vehicle electronics with network connections using one or more network protocols and can use a serial data communication architecture. Examples of suitable network connections include a controller area network (CAN), a media-oriented system transfer (MOST), a local interconnection network (LIN), a local area network (LAN), and other appropriate connections such as Ethernet or others that conform with known ISO, SAE, and IEEE standards and specifications, to name but a few. In other embodiments, a wireless communications network that uses short-range wireless communications (SRWC) to communicate with one or more VSMs of the vehicle can be used. In one embodiment, the vehicle 12 can use a combination of a hardwired communication bus 59 and SRWCs. The SRWCs can be carried out using the telematics unit 30, for example.

The vehicle 12 can include numerous vehicle system modules (VSMs) as part of vehicle electronics 20, such as the GNSS receiver 22, BCM 24, PEPS module 25, Power Rear Closure module 27 (PRC module 27), telematics unit 30 (vehicle communications system), vehicle-user interfaces 50-61, and onboard computer 60, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is hardwire connected by communication bus 59 to the other VSMs including the telematics unit 30. Moreover, each of the VSMs can include and/or be communicatively coupled to suitable hardware that enables intra-vehicle communications to be carried out over the communication bus 59; such hardware can include, for example, bus interface connectors and/or modems. One or more VSMs 28 may periodically or occasionally have their software or firmware updated and, in some embodiments, such vehicle updates may be over the air (OTA) updates that are received from a remote computer or facility via a land network (not shown) and telematics unit 30. As is appreciated by those skilled in the art, the above-mentioned VSMs are only examples of some of the modules that may be used in vehicle 12, as numerous others are also possible. It should also be appreciated that these VSMs can otherwise be known as electronic control units, or ECUs.

Global navigation satellite system (GNSS) receiver 22 receives radio signals from a constellation of GNSS satellites (not shown). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites (not shown). And, in another example, GNSS receiver 22 can be a BDS receiver that receives a plurality of GNSS (or BDS) signals from a constellation of GNSS (or BDS) satellites. The GNSS received can determine a current vehicle location based on reception of a plurality of GNSS signals from the constellation of GNSS satellites. The vehicle location information can then be communicated to the telematics unit 30, or other VSMs, such as the onboard computer 60. In one embodiment (as shown in FIG. 1), the telematics unit 30 and/or a telematics unit can be integrated with the GNSS receiver 22 so that, for example, the GNSS receiver 22 and the telematics unit 30 (or the wireless communications device) are directly connected to one another as opposed to being connected via communication bus 59. In other embodiments, the GNSS receiver 22 is a separate, standalone module or there may be a GNSS receiver 22 integrated into the telematics unit 30 in addition to a separate, standalone GNSS receiver connected to telematics unit 30 via communication bus 59.

Body control module (BCM) 24 can be used to control various VSMs 28 of the vehicle, as well as obtain information concerning the VSMs, including their present state or status, as well as sensor information. The BCM 24 is shown in the exemplary embodiment of FIG. 1 as being electrically coupled to the communication bus 59. In some embodiments, the BCM 24 may be integrated with or part of a center stack module (CSM) and/or integrated with telematics unit 30 or the onboard computer 60. Or, the BCM may be a separate device that is connected to other VSMs via bus 59. The BCM 24 can include a processor and/or memory, which can be similar to processor 36 and memory 38 of telematics unit 30, as discussed below. The BCM 24 may communicate with telematics unit 30 and/or one or more vehicle system modules, such as an engine control module (ECM), driver monitoring system 71, audio system 56, or other VSMs 28; in some embodiments, the BCM 24 can communicate with these modules via the communication bus 59. Software stored in the memory and executable by the processor enables the BCM to direct one or more vehicle functions or operations including, for example, controlling central locking, controlling an electronic parking brake, power sun/moon roof, the vehicle's head lamps, air conditioning operations, power mirrors, controlling the vehicle primary mover (e.g., engine, primary propulsion system), and/or controlling various other vehicle system modules (VSMs).

A passive entry passive start (PEPS) module 25 provides passive detection and authentication of the absence or presence of a passive physical key or a virtual vehicle key. When the passive physical key approaches (e.g., keyfob 63), the PEPS module 25 can determine if the passive physical key is authentic as belonging to the vehicle 12. The PEPS can likewise use authentication information received from data center 18 to determine if a mobile computing device 57 with virtual vehicle key (discussed below) is authorized/authentic to vehicle 12. If the virtual vehicle key is deemed authentic, the PEPS module 25 can send a command to BCM 44 permitting access to the vehicle 12. The PEPS module 25 can also provide passive entry health information to ensure sufficient module functionality for the passive physical key or virtual vehicle key operations. It should be understood that the PEPS module 25 may be an electronic hardware component connected to the vehicle bus 59 or, in an alternative embodiment, may be one or more software code segments uploaded to electronic memory 40.

PRC module 27 provides direct control of actuators for opening, closing, unlatching, latching, and cinching operations of devices such as closure latches, spindle actuators, gear motor assemblies, etc. The power rear closure module may receive information over the vehicle bus 59 from the body control module 24, the PEPS module 25, or other vehicle system modules 28.

Onboard computer 60 can otherwise be known as an electronic control unit (ECU) and controls one or more of the electrical systems or subsystems of vehicle 12. As follows, onboard computer 60 functions as a central vehicle computer that can be used to carry out various vehicle tasks. Also, one or more other VSMs can be incorporated with or controlled by onboard computer 60. These VSMs can include, but are not limited to, the engine control module (ECM), powertrain control module (PCM), transmission control module (TCM), body control module (BCM), brake control module (EBCM), center stack module (CSM), central timing module (CTM), general electronic module (GEM), body control module (BCM), and suspension control module (SCM).

Telematics unit 30 is capable of communicating data via SRWC through use of SRWC circuit 32 and/or via cellular network communications through use of a cellular chipset 34, as depicted in the illustrated embodiment. The telematics unit 30 can provide an interface between various VSMs of the vehicle 12 and one or more devices external to the vehicle 12, such as one or more networks or systems at a remote call center (e.g., ON-STAR by GM). This enables the vehicle to communicate data or information with remote systems at a remote call center.

In at least one embodiment, the telematics unit 30 can also function as a central vehicle computer that can be used to carry out various vehicle tasks. In such embodiments, the telematics unit 30 can be integrated with the onboard computer 60 such that the onboard computer 60 and the telematics unit 30 are a single module. Or, the telematics unit 30 can be a separate central computer for the vehicle 12 in addition to the onboard computer 60. Also, the wireless communications device can be incorporated with or a part of other VSMs, such as a center stack module (CSM), body control module (BCM) 24, an infotainment module, a head unit, a telematics unit, and/or a gateway module. In some embodiments, the telematics unit 30 is a standalone module, and can be implemented as an OEM-installed (embedded) or aftermarket device that is installed in the vehicle.

In the illustrated embodiment, telematics unit 30 includes the SRWC circuit 32, the cellular chipset 34, a processor 36, memory 38, SRWC antenna 33, and antenna 35. The telematics unit 30 can be configured to communicate wirelessly according to one or more SRWC protocols such as any of the Wi-Fi™, WiMAX™, Wi-Fi™ Direct, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. And, in some embodiments, the telematics unit 30 can be configured to communicate using IEEE 802.11p such that the vehicle can carry out vehicle-to-vehicle (V2V) communications, or vehicle-to-infrastructure (V2I) communications with infrastructure systems or devices, such as at a remote call center. And, in other embodiments, other protocols can be used for V2V or V2I communications.

The SRWC circuitry 32 enables the telematics unit 30 to transmit and receive SRWC signals, such as BLE or UWB signals. The SRWC circuit can allow the telematics unit 30 to connect to another SRWC device (e.g., a smart phone). Additionally, in some embodiments, the telematics unit 30 contains a cellular chipset 34 thereby allowing the device to communicate via one or more cellular protocols, such as those used by cellular carrier system 70, through antenna 35. In such a case, the telematics unit 30 is user equipment (UE) that can be used to in carry out cellular communications via cellular carrier system 70.

Antenna 35 is used for communications and is generally known to be located throughout vehicle 12 at one or more locations external to the telematics unit 30. Using antenna 35, telematics unit 30 may enable the vehicle 12 to be in communication with one or more local or remote networks (e.g., one or more networks at a remote call center or server) via packet-switched data communication. This packet switched data communication may be carried out through use of a non-vehicle wireless access point or cellular system that is connected to a land network via a router or modem. When used for packet-switched data communication such as TCP/IP, the telematics unit 30 can be configured with a static Internet Protocol (IP) address or can be set up to automatically receive an assigned IP address from another device on the network such as a router or from a network address server.

Packet-switched data communications may also be carried out via use of a cellular network that may be accessible by the telematics unit 30. Telematics unit 30 may, via cellular chipset 34, communicate data over wireless carrier system 70. In such a scenario, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 36 executes various types of digitally-stored instructions, such as software or firmware programs stored in memory 38, which enable the telematics unit 30 to provide a wide variety of services. For instance, in one embodiment, the processor 36 can execute programs or process data to carry out at least a part of the method discussed herein. Memory 38 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. In one embodiment, the telematics unit 30 also includes a modem for communicating information over the communication bus 59.

Vehicle electronics 20 also includes a number of vehicle-user interfaces that provide vehicle occupants with a means of providing and/or receiving information, including visual display 50, pushbutton(s) 52, microphone 54, audio system 56, camera 58, and sensors 61. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the telematics unit 30 to provide other data, response, and/or control input. Audio system 56 provides audio output to a vehicle occupant and can be a dedicated, stand-alone system or part of the primary vehicle audio system. According to one embodiment, audio system 56 is operatively coupled to both vehicle bus 59 and an entertainment bus (not shown) and can provide AM, FM and satellite radio, CD, DVD, and other multimedia functionality. This functionality can be provided in conjunction with or independent of an infotainment module. Microphone 54 provides audio input to the telematics unit 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display 50 is preferably a touch-screen graphics display and can be used to provide a multitude of input and output functions. Display 50 can be a touch screen on the instrument panel, a heads-up display reflected off of the windshield, a video projector that projects images onto the windshield from the vehicle cabin ceiling, or some other display. For example, display 50 can be the touch screen of the vehicle's infotainment module at the center console of the vehicle's interior. Various other vehicle-user interfaces can also be utilized, as the interfaces of FIG. 1 are only an example of one particular implementation.

Camera 58 can be of the digital variety and can capture one or more images that can then be transmitted to telematics unit 30 and processor 36. The camera(s) 58 can be installed on the rear fascia of the vehicle body and can be positioned to capture a video feed that will assist a vehicle operator in backing up and parking the vehicle 12. Sensor 61 can be of the ultrasonic transducer or radar variety and can be installed on the rear fascia of the vehicle body to aid the vehicle operator in reversing into or backing out of parking spaces.

Vehicle keyfob 63 generally performs conventional remote keyless entry (RKE) functions (which can be via telematics unit 30 in conjunction with PEPS module 25). Moreover, the term “keyfob,” as used herein, broadly includes not only separate transmitters attached to a key or set of keys by a loop or tether, but also portable remote transmitters regardless of whether they are attached to keys, as well as remote transmitters that are integrated together with a vehicle key as a single component. According to one embodiment, amongst other components, keyfob may include a protective housing, several user buttons, an RKE circuit, a power source, and an antenna. As is generally known of wireless keyfobs 63, the user buttons enable a user to selectively activate different RKE functions at vehicle 12, including, but not limited to, locking and unlocking a door, arming and disarming a vehicle alarm system, activating a trunk release, panic signaling, remote ignition starting, and turning on interior and exterior lights. Of course, other buttons and RKE functions known in the art could also be used, including RKE functions that are performed automatically without the use of user buttons. Keyfob 63 may automatically be paired/linked with telematics unit 30 via a SRWC protocol (e.g., Bluetooth Low Energy, Wi-Fi, Ultra-Wideband (UWB), etc.) when within a wireless range.

As revealed above, one of the networked devices that can directly or indirectly communicate with the telematics unit 30 is a mobile computing device 57, such as (but not limited to) a smart phone, personal laptop computer or tablet computer having two-way communication capabilities, a wearable computer such as (but not limited to) a smart watch or glasses, or any suitable combinations thereof. The mobile computing device 57 can include computer processing capability, a mobile memory, and a transceiver capable of communicating with remote locations (e.g., data center (not shown), amongst other features. Examples of the mobile computing device 57 include the IPHONE™ and APPLE WATCH™ each being manufactured by Apple, Inc., and the GALAXY™ smart phone manufactured by Samsung Electronics Company as well as others.

Mobile device 57 may be used inside or outside of a vehicle, and may be coupled to the vehicle by wire or wirelessly. Mobile device 57 may also be configured to provide services according to a subscription agreement with a third-party facility or wireless/telephone service provider. It should be appreciated that various service providers may utilize the wireless carrier system 70 and that the service provider of telematics unit 30 may not necessarily be the same as the service provider of mobile device 57.

When using the SRWC protocol, mobile computing device 57 and telematics unit 30 may pair with each other (or link to one another) on a case-by-case basis and while within a wireless range; SRWC pairing is known to skilled artisans. The SRWC protocol may be an aspect of telematics unit 30 or may be part of one or more independent VSMs 28 such as the PEPS module 25. Once SRWC is established, the devices may be considered bonded (i.e., they may recognize one another and/or connect automatically when they are in a predetermined proximity or range of one other. In other words—they may become, at least temporarily, network participants). This unique pairing, for example, allows mobile computing device 57 to act as the virtual keyfob briefly mentioned above. To illustrate how this occurs—after paring has been established, mobile computing device 57 will send its virtual vehicle key aspect to telematics unit 30

for recognition in light of its stored corresponding virtual key aspect and in turn the PEPS module 25 may establish mobile computing device 57 as the acting key fob for vehicle 12.

### Method

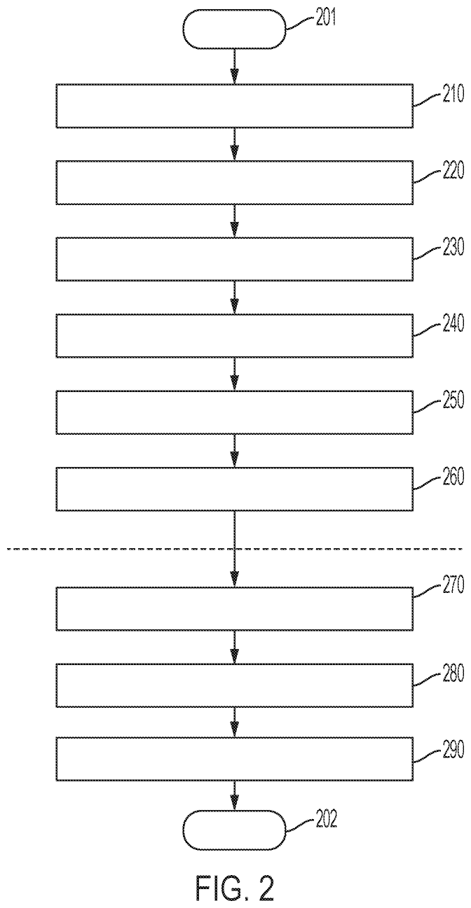

Turning now to FIGS. 2 through 4, there is shown an embodiment of a method 200 for presence based vehicle liftgate operation. For example, method 200 can allow a vehicle user to open its rear liftgate without the need to press a button or make a unique motion. One or more aspects of liftgate operation method 200 may be carried out by electronics control module 60 (i.e., onboard computer 60) implementing a memory and processor to complete the method steps. Skilled artists will also see that one or more aspects of liftgate operation method 200 could alternatively/additionally be carried out by telematics unit 30. For example, in order to carry out the one or more aspects of method 200, memory 38 includes executable instructions stored thereon and processor 36 executes these executable instructions. One or more ancillary aspects of method 200 may also be completed by one or more vehicle devices such as, for example, PEPS module 25, camera 58, and sensors 61. It should be understood that method 200 could be applied to vehicle doors (power closures) that are not the rear liftgate. For example, method 200 could be applied to the lid of a vehicle's trunk or one or more side doors of the vehicle 12.

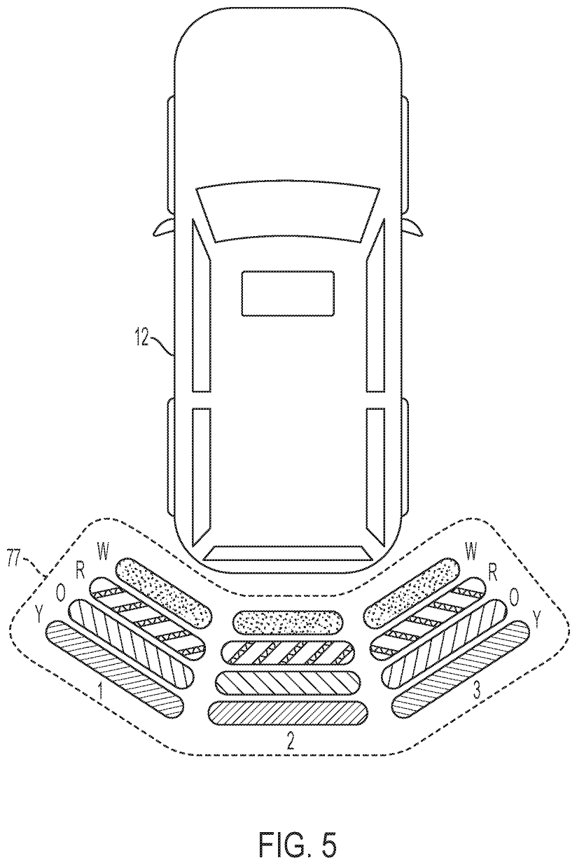

Method 200 begins at 201 in which the vehicle 12 is parked and in the park gear. In step 210, a user 75 will approach vehicle and PEPS module 25 will identify them via a connection that is created with their keyfob 63 or mobile computing device 57 (i.e., virtual keyfob). Moreover, upon this identification occurring, PEPS module 25 will initiate camera 58 and sensors 61. In step 220, a user 75 will enter a zone 77 that has been established behind the rear bumper fascia of vehicle 12. As can be seen, the zone 77 can be defined by the areas that surround the rear end of vehicle 12 and which are sensed by sensors 61 and/or camera 58 (see FIG. 5). In one or more embodiments, a light projector (e.g., an LED projector), which has been installed underneath rear bumper fascia of vehicle 12, will project a graphical representation of zone 77 (i.e., a representation cue) onto the ground behind the bumper so as to facilitate the user's 75 understanding of the physical boundaries of zone 77.

In step 230, in one or more embodiments, the presence of the user 75 entering within the zone 77 is recognized via sensor 61. In one or more alternative embodiments, the presence of the user 75 within the zone 77 is recognized via camera 58. As follows, in such embodiments, known object recognition techniques may be employed to recognize the user 75 as being within the zone 77. In addition, the intent of the user 75 to open the liftgate 81 may be recognized based on the user's movements while within the zone 77 (discussed below). Once the user 75 is at least recognized to be within zone 77, an acknowledgement cue will be provided to let the user 75 know that, if desired, the hands-free sequence to open the vehicle's liftgate 81 can begin. As follows, the taillights 79 of vehicle 12 will at least temporarily activate to provide a notification to the user 75 (e.g., one or two blinks of the light). The acknowledgment cue may also be accompanied by an audio notification (e.g., one or more horn honks). An arbitration process may also occur after the sensor/camera information and keyfob information has been collected to verify that the user 75 is actually within the established zone 77. It should be noted that while taillights 79 and vehicle horn chirps can provide feedback, other visual and audible devices may be used, such as, but not limited to, a piezoelectric buzzer, audio tones or files played through audio system 56, reverse lights, center high-mount stop lamp (CHMSL), or LED strip lighting. In addition, when an audio file is played via audio system 56, the audio file can tell the user 75 how much time they will be required to remain in zone 77 before the liftgate will be operated to open (i.e., a prescribed duration of time).

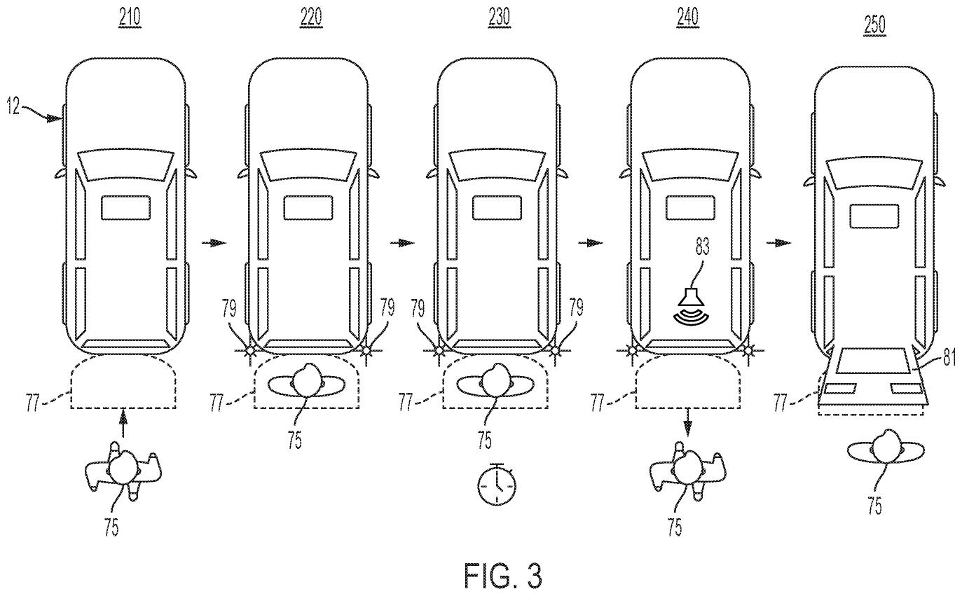

In step 240, it is recognized that the user 75 has remained within zone 77 for at least the prescribed duration of time (e.g., two (2) seconds). As follows, the user 75 has not left the zone 77 nor have they substantially moved around within the zone 77 for the prescribed duration of time (e.g., two (2) seconds). It should be understood that the acknowledgement cue can last as long as the prescribed period of time (e.g., the taillights can remain on for the duration of this time period or an audio file can be played that provides a count down sequence). In step 250, an initiation cue 83 is provided to let the user 75 to know to remove themselves from zone 77 as liftgate 81 opens. The initiation cue 83 may also be an audio notification (e.g., one or more horn honks or an audio file that provides instructions for the user). In addition, in this step, the user 75 will backup and move their body entirely out of the zone 77 (as represented in FIG. 3). However, if the user 75 is recognized to remain within the zone for longer than a second prescribed time period (e.g., five (5) seconds), then the liftgate 81 will be inhibited such that it will not be able to open on departure and an additional user request or gesture will be required to re-initiate. Thus, at least the vehicle system designed to move the liftgate 81 from the closed-to-open positions (e.g., PRC module 27) will be disabled. In step 260, the user 75 will be recognized as no longer remaining within zone 77. Moreover, in this step, the liftgate 81 will be operated to automatically open as controlled by PRC module 27. Upon being moved into the open position, the user 75 will be able to place one or more objects in the vehicle's cargo area.

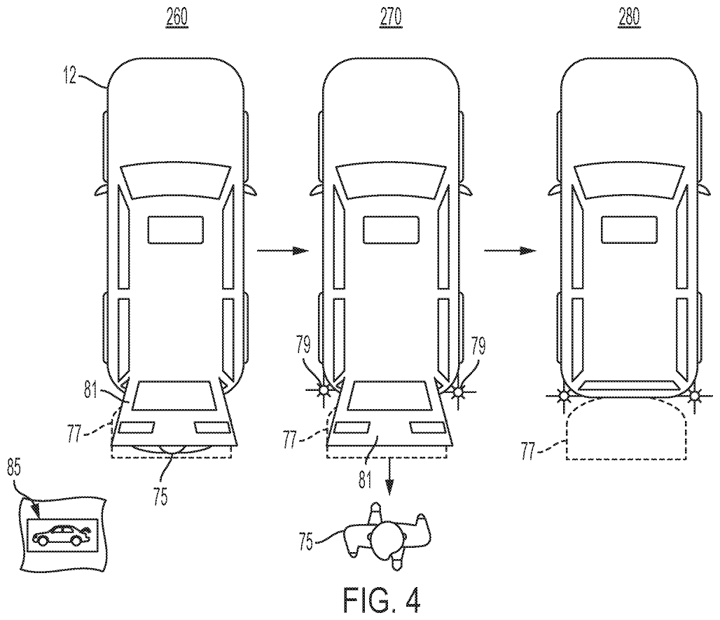

After some duration of time (e.g., as long as it takes the user 75 to place one or more objects in the cargo area), in step 270, a signal is received that indicates the user 75 is ready to automatically close the liftgate 81. In one or more embodiments, the signal is provided by a button 85 that is installed on one of the side panels of the vehicle's cargo area (see FIG. 4). In one or more alternative embodiments, the signal may be received via camera 58 and/or sensor 61. For example, upon the user providing some kind of physical gesture (e.g., moving their hand from an upward to downward position). In one or more alternative embodiments, the signal may be received by mobile computing device 57 (e.g., via the user pressing a virtual button presented via a GUI) or keyfob 63 (e.g., via the user pressing a physical button embedded on the fob). In step 270, another acknowledgement cue (i.e., a second acknowledgement cue) will be provided to let the user 75 know to remove themselves from the zone 77 before the liftgate 81 can operate to close. As follows, the taillights 79 of vehicle 12 will at least temporarily activate to provide a notification to the user 75 (e.g., one or two blinks of the light). This second acknowledgment cue may also be accompanied by an audio notification (e.g., one or more horn honks or an audio file that provides instructions for the user). Moreover, in this step, the user 75 will backup and remove themselves from zone 77 (as represented in FIG. 4). However, if the user 75 is recognized to remain within the zone 77 for longer than a second prescribed time period (e.g., sixty (60) seconds), then the liftgate 81 will be inhibited such that it will not be able to close on departure and an additional user request or gesture will be required to re-initiate. Thus, at least the vehicle system (e.g., PRC module 27) that moves the liftgate 81 from the open-to-closed positions will be disabled. In step 280, the user 75 will be recognized as no longer remaining within zone 77. Moreover, in this step, the liftgate 81 will be operated to automatically close. As follows, objects will now be held in the vehicle cargo area by the closed liftgate 81. After step 280, method 200 will move to completion 202.

As shown in FIG. 5, the user's intent to open the liftgate 81 can be determined based on their movement within the zone 77. As shown, the zone 77 can be divided into subsections (trajectory sections) consisting of three columns and four rows. The columns can be numbered one (1), two (2), and three (3). Whereas, the rows can be titled Yellow (Y), Orange (O), Red (R), and Wine (W). Moreover, movement/motion within each subsubsection can be monitored by camera 58 and/or sensor 61. Thus, the user's trajectory can be determined by the subsections in which the user 75 moves while in zone 77. From there, the user's intent while within zone 77 can be determined. For example, when the user 75 enters zone 77 via column two (2) and is found to move along a path of 2Y->2O->2R->2 W (when the user 75 walked directly up to the rear bumper fascia of vehicle 12) or, alternatively, 2Y->2O->2R->2 W->2R->2O (when the user 75 walks up to the rear bumper fascia and then backs up slightly from the bumper), then it can be determined that the user 75 intends to open liftgate 81 to enter their vehicle's cargo area. However, when the user 75 enters zone 77 via column 1 and is found to move along a path of 1 W->2 W->3 W or, alternatively, 1R->2R->3R, then it can be determined that the user 75 is simply walking past vehicle 12 and does not intend to enter their vehicle's cargo area (and thus the liftgate 81 will not be operated to open).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A method for presence-based vehicle door operation, the method comprising:
establishing a defined zone in an environment surrounding a vehicle;
recognizing a presence of a user within the zone;
recognizing the user has remained within the zone for a prescribed time period;
recognizing the user no longer remains within the zone; and
causing the vehicle door to open after recognizing the user no longer remains within the zone.

2. The method of claim 1, further comprising:
recognizing the movement of the user within the zone;
determining an intent of the user based on the movement of the user within the zone; and
based on the intent of the user, causing the vehicle door to open.

3. The method of claim 1, further comprising: providing an acknowledgement cue after recognizing the presence of the user.

4. The method of claim 1, further comprising: providing an initiation cue after recognizing the user has remained within the zone for the prescribed time period.

5. The method of claim 1, wherein the prescribed period of time is at least two (2) seconds.

6. The method of claim 1, wherein the user is identified based on the location of a keyfob in relation to the zone.

7. A method for presence-based vehicle door operation, the method comprising:
establishing a defined zone in an environment surrounding a vehicle;
receiving a signal to close the vehicle door;
recognizing a user no longer remains within the zone; and
causing the vehicle door to close after recognizing the user no longer remains within the zone.

8. The method of claim 7, wherein: when the user is recognized to remain within the zone beyond a prescribed time period, inhibit the vehicle door from being able to close.

9. The method of claim 7, further comprising: providing an acknowledgement cue after receiving the signal.

10. The method of claim 7, wherein the user is identified based on the location of a keyfob in relation to the zone.

11. The method of claim 7, wherein the signal is provided by a button located in proximity to the zone.

12. A method for presence-based vehicle door operation, the method comprising:
establishing a defined zone in an environment behind of the vehicle door of a vehicle;
recognizing a presence of a user within the zone;
recognizing the user has remained within the zone for a prescribed time period;
for a first time, recognizing the user no longer remains within the zone;
causing the vehicle door to open after recognizing the user no longer remains within the zone for the first time;
after the user returns to the zone, receiving a signal to close the vehicle door;
for a second time, recognizing the user no longer remains within the zone; and
causing the vehicle door to close after recognizing the user no longer remains within the zone for the second time.

13. The method of claim 12, further comprising:
recognizing the movement of the user within the zone;
determining an intent of the user based on the movement of the user within the zone; and
based on the intent of the user, causing the vehicle door to open and/or close.

14. The method of claim 12, further comprising: providing an acknowledgement cue after recognizing the presence of the user.

15. The method of claim 12, further comprising: providing an initiation cue after recognizing the user has remained within the zone for the prescribed time period.

16. The method of claim 12, wherein the prescribed period of time is at least two (2) seconds.

17. The method of claim 12, wherein the user is identified based on the location of a keyfob in relation to the zone.

18. The method of claim 12, wherein: after the user returns to the zone, when the user is recognized to remain within the zone for a second prescribed time period, inhibit the vehicle door from being able to close.

19. The method of claim 12, further comprising: providing an acknowledgement cue after receiving the signal.
